(19) United States
(12) Patent Application Publication
(10) Pub. No.: US 2011/0085601 A1
(43) Pub. Date: Apr. 14, 2011

(54) VIDEO DECODING APPARATUS AND METHOD BASED ON MULTIPROCESSOR

(75) Inventors: Jae Jin Lee, Chungcheongbuk-do (KR); Jun Young Lee, Busan (KR); Moo Kyoung Chung, Daejeon (KR); Seong Mo Park, Daejeon (KR); Nak Woong Eum, Daejeon (KR)

(73) Assignee: ELECTRONICS AND TELECOMMUNICATIONS RESEARCH INSTITUTE, Daejeon (KR)

(21) Appl. No.: 12/836,979

(22) Filed: Jul. 15, 2010

(30) Foreign Application Priority Data
Oct. 8, 2009 (KR) 10-2009-0095604

(51) Int. Cl. H04N 7/26

(52) U.S. Cl. 375/240.25; 375/E07.027

(57) ABSTRACT

Disclosed are a multiprocessor-based video decoding apparatus and method. The multiprocessor-based video decoding apparatus includes: a stream parser dividing an input stream by row and parsing a skip counter and a quantization parameter of the input stream; and a plurality of processors acquiring the plurality of divided streams, the skip counter, and the quantization parameter generated by the stream parser, acquiring decoded information of an upper processor among neighboring processors by row, and parallel-decoding the plurality of divided streams by row. Decoding of an input stream can be parallel-processed by row.

### CROSS-REFERENCE TO RELATED APPLICATIONS

This application claims the priority of Korean Patent Application No. 10-2009-95604 filed on Oct. 8, 2009, in the Korean Intellectual Property Office, the disclosure of which is incorporated herein by reference.

### BACKGROUND OF THE INVENTION

1. Field of the Invention

The present invention relates to a video decoding technique and, more particularly, to a video decoding technique based on a multiprocessor capable of effectively parallel-processing input streams.

The present invention is derived from research conducted as a part of IT growth power industrial technology development work supported by the IT R&D program of MIC/IITA and the Knowledge Economics Department [Project Management No.: 2007-S-026-03, Project title: MPCore Platform-based Multi-format Multimedia Soc].

2. Description of the Related Art

A video compression/restoration technique requisite for multimedia is implemented by new video compression standards such as H.264/AVC, VC-1, AVS, and the like, having a very high compression rate and allowing for reliable transmission, as well as MPEG currently used for HDTV broadcasting.

In particular, as these video compression standards are combined with next-generation services such as digital data broadcasting, next-generation mobile phones, IPTV, satellite DMB, and the like, their applications are anticipated.

The video compression technique has been developed for the purpose of minimizing a bandwidth use by reducing bit size while maintaining restored screen image picture quality as high as the original.

Compared with existing video compression standards such as MPEG-2, the new video compression standards have an algorithm with remarkably increased complexity and request a large amount of calculation, which thus require dedicated hardware or a device for real time compression/restoration.

Recently, attempts to realize a multiprocessor-based multi-format video decoding method propelled by the flexibility, the merit of a processor over hardware, and an improvement of a processing technique and performance of the processor have continued.

However, video standards involve interdependence of data in a single screen image (i.e., intra-screen data) as well as interdependence of data between screen images (i.e., inter-screen data), so they are not qualified for implementing a parallel processing of a multiprocessor-based video decoding system, and an optimum solution to this has yet to be proposed.

The related art dividing scheme for parallel-processing includes a data dividing (or partitioning) scheme in which data, itself processed by a processor, is divided and a function dividing scheme in which a function module is divided in a pipeline manner and processed.

FIG. 1 illustrates a multiprocessor-based video decoding apparatus employing the data dividing scheme according to the related art.

As shown in FIG. 1, in the data dividing scheme, an input stream is divided into a plurality of data fragments 111 to 116 according to a certain level (e.g., frame, slide, a macroblock row, macroblock (16×16), block (4×pixel)), and each of the divided data is parallel-processed by different processors 121 to 123.

The data dividing scheme illustrated in FIG. 1 can make data streams highly parallel, provided the divided data have no interdependence therebetween, but is ineffective for a multimedia application which has intra-screen or inter-screen data dependency.

FIG. 2 illustrates a multiprocessor-based video decoding apparatus employing the function dividing scheme according to the related art.

As shown in FIG. 2, in the function dividing scheme, a decoding function is divided into a plurality of functions 211 to 216, and the divided functions are parallel-processed by different processors 221 to 226.

However, in the function dividing scheme, when a performing time of the processors is different, resource efficiency is degraded, so a process for uniformly dividing the function is additionally required. Also, when a particular processor requires a relatively long processing time, the usability of the other remaining processors is degraded by the excessive processing time of the corresponding processor, resulting in a reduction of the parallel processing characteristics and the effective utilization of the video decoding apparatus.

Also, when the video decoding apparatus is completely designed, the performance and processable stream size of the video decoding apparatus cannot be altered due to the fixed pipe line structure of the function dividing scheme, so the function dividing scheme has relatively low expandability and generality.

### SUMMARY OF THE INVENTION

An aspect of the present invention provides a video decoding apparatus and method capable of maximizing parallel characteristics and the utilization of a decoding operation, regardless of data dependency.

Another aspect of the present invention provides a video decoding apparatus and method capable of effectively implementing a multimedia decoding system with limited memory resources by minimizing inter-processor communication overhead.

According to an aspect of the present invention, there is provided a multiprocessor-based video decoding apparatus including: a stream parser dividing an input stream by row and parsing a skip counter and a quantization parameter of the input stream; and a plurality of processors acquiring the plurality of divided streams, the skip counter and the quantization parameter generated by the stream parser, acquiring decoded information of an upper processor among neighboring processors by row, and parallel-decoding the plurality of divided streams by row.

The multiprocessor-based video decoding apparatus may further include: a plurality of stream buffers parallel-storing the plurality of divided streams generated by the stream parser; and a plurality of shared memories shared by neighboring processors and providing decoded information of an upper processor among the neighboring processors to a lower processor among the neighboring processors. The multiprocessor-based video decoding apparatus may further include: a frame memory storing the skip counter and the quantization parameter as necessary.

The decoded information of the upper processor may include information regarding an X coordinate, a type and intra and motion vector prediction values of a macroblock decoded by the upper processor among the neighboring processors.

Each of the plurality of processors may perform decoding on the divided stream stored in a stream buffer corresponding to each individual processor by using the skip counter and the quantization parameter stored in the frame memory and the intra and motion vector prediction values included in the decoded information of the upper processor.

Each of the plurality of processors may determine whether to perform decoding on the divided stream upon checking data dependency according to an intra and motion vector direction through the X coordinate included in the decoded information of the upper processor.

Each of the plurality of processors may have a function of collecting the decoded information regarding the divided stream which has been decoded by each individual processor and storing the collected decoded information in a shared memory shared by each individual processor and a lower processor, or a function of storing the result of the decoding operation in the frame memory.

The number of the plurality of stream buffers, the plurality of processors, and the plurality of shared memories may be adjustable according to the performance of the video decoding apparatus and the size of a stream to be processed.

According to another aspect of the present invention, there is provided a multiprocessor-based video decoding method using a stream parser and a plurality of processors, including: a preprocessing and parsing operation of dividing, by the stream parser, an input stream by row and parsing a skip counter and a quantization parameter of the input stream; an acquiring operation of acquiring, by the plurality of processors, the plurality of divided streams, the skip counter and the quantization parameter generated by the stream parser and acquiring decoded information of an upper processor among neighboring processors by row; and a parallel-decoding operation of parallel-decoding, by the plurality of processors, the plurality of divided streams by row by using the information acquired by the plurality of processors in the acquiring operation.

The preprocessing and parsing operation may include: dividing the input stream by row and parallel-storing the divided input streams in a plurality of stream buffers; and parsing the input stream to extract the skip counter and the quantization parameter and storing the extracted skip counter and the quantization parameter in the frame memory.

The acquiring operation may include: acquiring, by each of the plurality of processors, the divided streams stored in a stream buffer corresponding to each of the plurality of processors and the skip counter and the quantization parameter stored in the frame memory; and reading, by each of the plurality of processors, a shared memory shared by each individual processor and an upper processor to acquire the decoded information of the upper processor by row.

The decoded information of the upper processor may include information regarding an X coordinate, a type and intra and motion vector prediction values of a macroblock decoded by the upper processor among the neighboring processors.

The acquiring operation may include: determining whether to enter the acquiring operation upon checking data dependency according to an intra and motion vector direction through the X coordinate included in the decoded information of the upper processor.

The parallel-decoding operation may include: performing, by each of the plurality of processors, decoding on the divided streams acquired in the acquiring operation by using the skip counter and the quantization parameter and the decoded information of the upper processor; and collecting, by each of the plurality of processors, decoded information regarding the divided streams which have been decoded by each individual processor and storing the collected decoded information in a shared memory shared by each individual processor and a lower processor.

The multiprocessor-based video decoding method may further include: storing, by the plurality of processors, the results of the decoding operation performed on the plurality of divided streams in the frame memory, after the parallel-decoding operation.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a multiprocessor-based video decoding apparatus employing a data dividing scheme according to the related art;

FIG. 2 illustrates a multiprocessor-based video decoding apparatus employing a function dividing scheme according to the related art;

FIG. 3 is a view for explaining a data dependency of a video compression standard;

FIG. 4 is a schematic block diagram of a multiprocessor-based video decoding apparatus according to an exemplary embodiment of the present invention;

FIG. 5 is a flow chart illustrating the process of a video decoding method according to an exemplary embodiment of the present invention; and

FIG. 6 is a view for explaining in detail the video decoding method according to an exemplary embodiment of the present invention.

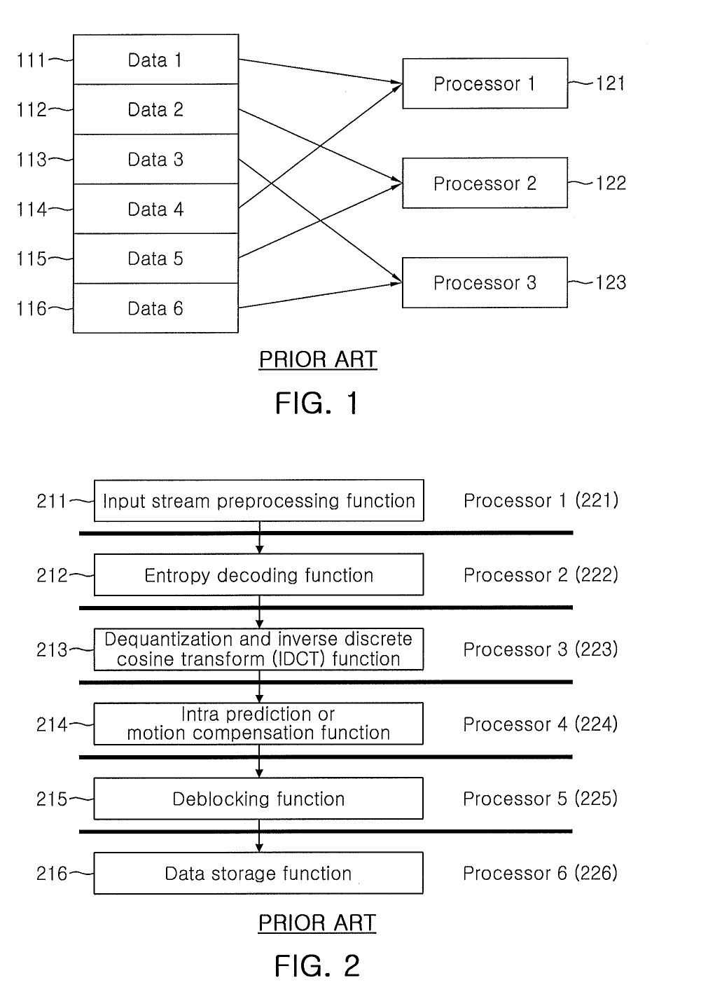

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art. In the drawings, the shapes and dimensions may be exaggerated for clarity, and the same reference numerals will be used throughout to designate the same or like components.

Unless explicitly described to the contrary, the word “comprise” and variations such as “comprises” or “comprising,” will be understood to imply the inclusion of stated elements but not the exclusion of any other elements.

Before describing a video decoding apparatus and method according to the present invention, the interdependency of data generated during a video decoding operation will first be described to help understand the present invention as follows.

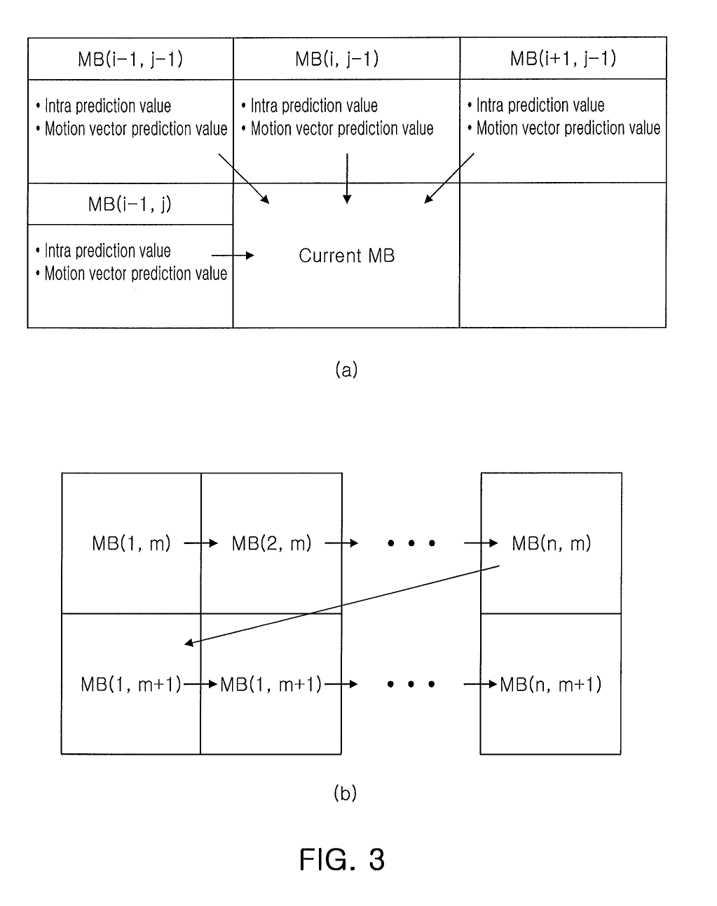

FIG. 3 is a view for explaining a data dependency of a video compression standard. In FIG. 3, (a) shows data dependency according to an intra and motion vector direction, and (b) shows data dependency according to a skip counter and the quantization parameter.

With reference to FIG. 3(a), in order for a video stream to perform an intra and motion vector prediction on a current macroblock (MB), intra and motion vector prediction values of neighboring MBs are necessary.

With reference to FIG. 3(b), after a current row is decoded, a skip counter and a quantization parameter are necessary in order to recognize a start point of a next row and normally decode it.

Thus, the present invention proposes a video decoding apparatus and method with a new structure capable of parallel-processing an input stream by row (i.e., in the unit of row) regardless of the data dependency as shown in FIG. 3.

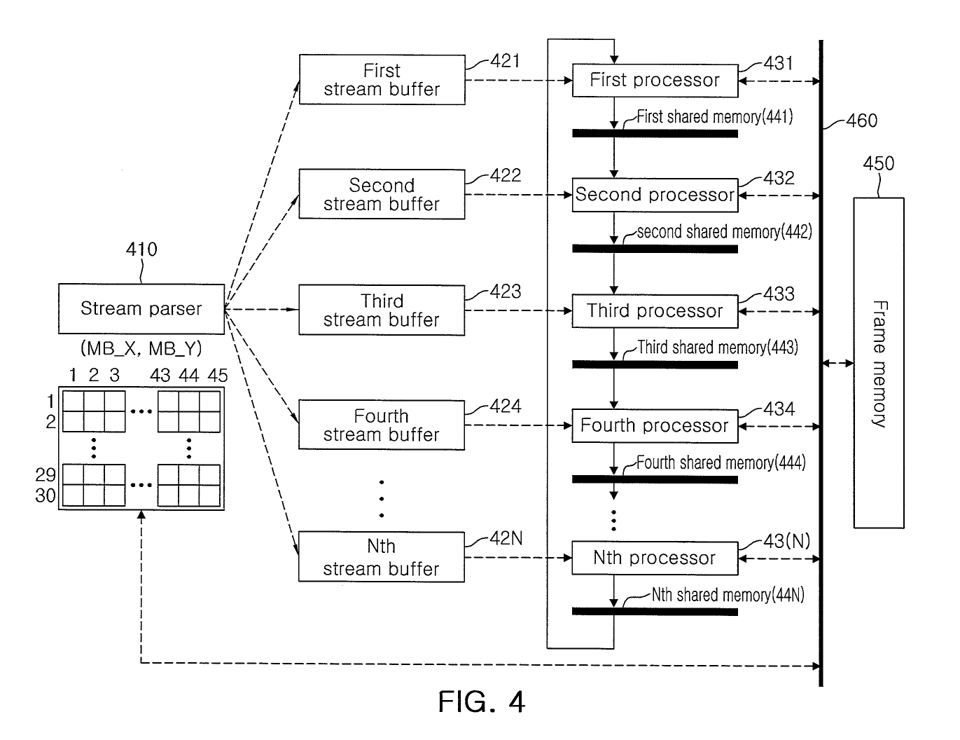

FIG. 4 is a schematic block diagram of a multiprocessor-based video decoding apparatus according to an exemplary embodiment of the present invention.

With reference to FIG. 4, the video decoding apparatus includes a stream parser 410, a plurality of stream buffers 421 to 42N, a plurality of processors 431 to 43N, a plurality of shared memories 441 to 44N, a frame memory 450, and a bus 460.

The number of the stream buffers, the processors, and the shared memories may be variably adjusted depending on the performance of a video decoding apparatus and the size of a stream to be processed.

The function of each element will now be described.

The stream parser 410 performs a parsing and preprocessing on an input stream. Namely, the stream parser 410 divides the input stream by row to generate a plurality of divided streams and parallel-stores the plurality of divided streams in the plurality of stream buffers 421 to 42N. Also, the stream parser 410 parses the input stream to extract a skip counter, a quantization parameter, and the like, and stores the extracted skip counter, quantization parameter, and the like, in the frame memory 450, so that the plurality of processors 431 to 43N can remove a data dependency according to the skip counter and the quantization parameter.

The stream parser 410 repeatedly performs the operation until such time as the input stream is null. The stream processor 410 is implemented as a high performance processor or hardware module supporting the high speed parsing and preprocessing operation, thereby minimizing a stream standby time of the processors 431 to 43N. This is to prevent the video decoding apparatus from having a degraded performance as the processors 431 to 43N otherwise wait for the stream, which is to be decoded, to be ready. Namely, because the stream standby time of the processors 431 to 43N is shortened, degradation of the performance of the video decoding apparatus can be prevented.

The plurality of stream buffers 421 to 42N parallel-transmit the plurality of divided streams which have been generated by the stream parser 410 to the plurality of processors 431 to 43N. Namely, the plurality of stream buffers 421 to 42N disposed between the stream parser 410 and the plurality of processors 431 to 43N support data communications between the stream parser 410 and the plurality of processors 431 to 43N.

The plurality of processors 431 to 43N parallel-process decoding of the plurality of divided streams by row.

To this end, each processor, for example, the processor 431, inspects (or checks) data dependency according to an intra and motion vector direction based on decoded information of an upper processor (in particular, an X coordinate of a macroblock decoded by the upper processor).

When the data dependency according to the intra and motion vector direction is satisfied (namely, when the decoding of macroblocks adjacent to a macroblock the processor 431 intends to decode has been completed), the processor 431 acquires the divided stream stored in the stream buffer 421 corresponding to the processor 431, the decoded information (in particular, an intra and motion vector prediction values of the macroblock which has been decoded by the upper processor 43N) stored in the shared memory 44N shared by the processor 431 and the upper processor 43N, the skip counter and the quantization parameter stored in the frame memory 450, and the like.

The processor 431 sequentially performs entropy decoding, dequantization, inverse discrete cosine transform, intra prediction, motion compensation, and deblocking operations on the divided stream through the acquired information, and then stores the results of the decoding operation (or the decoded video data) in the frame memory 450.

In this case, the decoded information of the upper processor includes information regarding the X coordinate and type of the macroblock decoded by the upper processor among the neighboring processors and the intra and motion vector prediction values.

Also, each processor, for example, the processor 431, collects its decoded information and stores it in the shared memory shared between the processor 431 and its lower processor, so that the lower processor can perform a decoding operation in the same manner.

The plurality of shared memories 441 to 44N are shared by only neighboring processors (namely, having locality), providing decoded information of an upper process among the neighboring processors to a lower processor among the neighboring processors. In this case, data communications between processors which are not adjacent may be performed through a particular area of the frame memory 450.

The frame memory 450 stores the skip counter and the quantization parameter parsed by the stream parser 410 and the decoded video data output from the plurality of processors 431 to 43N. In this case, the decoded video data is used as reference data for a deblocked image or a motion compensation of a macroblock later.

The bus 460 supports data communications between the stream parser 410 and the frame memory 450 or between the plurality of processors 431 to 43N and the frame memory 450.

In this manner, besides the streams divided by row, the information for eliminating the data dependency (Namely, the skip counter and the quantization parameter, the X coordinates of macroblocks adjacent to the macroblock to be currently decoded, the intra and motion vector prediction values, etc.) as shown in FIG. 3 is also provided to the plurality of processors. Accordingly, the plurality of processors 431 to 43N can parallel-process the input stream by row regardless of the data dependency as shown in FIG. 3, thus having a high usability.

Also, in the exemplary embodiment of the present invention, because data communications between neighboring processors are performed via the plurality of shared memories 441 to 44N, the usage amount of bus for inter-process communication can be reduced.

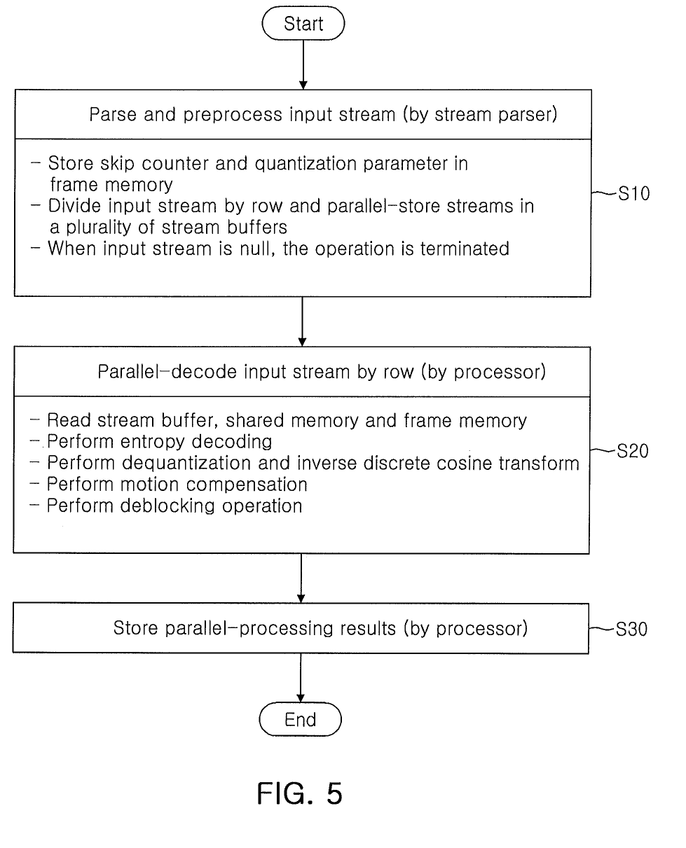

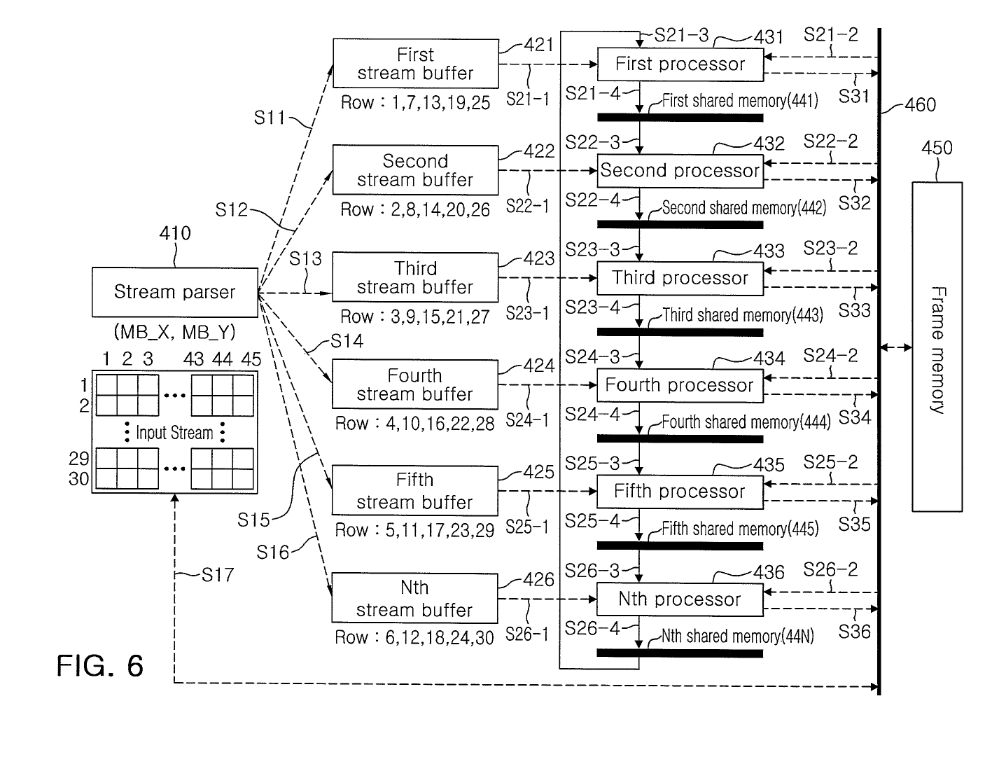

FIGS. 5 and 6 are views illustrating the video decoding method according to an exemplary embodiment of the present invention.

As shown in FIG. 5, the operation of the video decoding method according to an exemplary embodiment of the present invention includes a step S10 of parsing and preprocessing an input stream, a step S20 of parallel-decoding the input stream by row, and a step S30 of storing the results of the parallel-decoding operation.

The operation of the video decoding method will now be described in more detail with reference to FIG. 6. In FIG. 6, it is assumed that the video decoding apparatus receives a bit stream having a size of D1 (720*480 pixels) and a 40*35 number of macroblocks and includes six stream buffers 421 to 426, six processors 431 to 436, and six shared memories 431 to 436.

First, when an input stream is generated, the stream parser 410 divides the input stream by row and parallel-stores the divided streams of the first to six rows in the first to six stream buffers (i.e., 421 to 426). Also, the stream parser 410 parses the input stream to extract a skip counter and a quantization parameter, and stores the extracted skip counter and the quantization parameter in the frame memory 460 (S17).

The first processor 431 waits until such time as decoding of the macroblocks adjacent to the macroblock the first processor 431 is to decode is completed through the decoded information (in particular, the X coordinate of the macroblock decoded by the upper processor) stored in the sixth shared memory 446. When the decoding of the macroblocks adjacent to the macroblock the first processor 431 is to decode is completed, the first processor 431 reads the divided stream stored in the first stream buffer 421, the skip counter and the quantization parameter stored in the frame memory 450, and the decoded information (in particular, the intra and motion vector prediction values of the macroblock decoded by the upper processor) stored in the shared memory 446 (S21-1 and S21-2), and performs decoding on the divided stream of a first row. And at the same time, the first processor 431 stores the decoded information of the second row in the first shared memory 441 (S21-3).

Then, the second processor 432 checks data dependency as shown in FIG. 3(a) through the decoded information (namely, the decoded information of the first row) stored in the first shared memory 441, reads the divided stream of the first row stored in the second stream buffer 422, the decoded information stored in the first shared memory 441, and the skip counter and the quantization parameter stored in the frame memory 450 (S22-1, S22-2, and S22-3), and starts to perform decoding on the divided stream of a second row. Also, at the same time, the second processor 432 stores the decoded information of the second row in the second shared memory 442 (S22-4).

The other remaining processors 433 to 436 read the stream buffer corresponding to themselves, the frame memory, and the shared memory shared by each processor and an upper processor, perform a decoding operation, and informs a lower processor about the decoded information of a row they are processing.

When the first to sixth processors 431 to 436 complete their decoding operations after the lapse of a certain amount of time, they store the results of the decoding operations performed on the divided streams of the first to sixth rows in the frame memory 450 (S31 to S36).

Through the processes as described above, the first to sixth processors 431 to 436 can parallel-process decoding on the divided streams of the first to six rows regardless of the data dependency as shown in FIG. 3.

Also, the stream parser 410 parallel-stores the divided streams of the seventh to twelfth rows in the first to sixth stream buffers 421 to 426 before the first to sixth processors 431 to 436 complete their decoding operations (S11 to S16), so that the first to sixth processors 431 to 436 can continuously perform decoding operations on the divided streams of the seventh to twelfth rows.

These operations are repeatedly performed until such time as the input stream is null (namely, until when there is no more divided stream to be decoded or until when a new stream is not input). When there is no more input stream to be processed, the operations are terminated.

As set forth above, in the multiprocessor-based video decoding apparatus and method according to exemplary embodiments of the invention, because an input stream can be divided by row so as to be processed regardless of a data dependency, the parallel characteristics and utilization of a decoding operation can be maximized to enhance usability of a processor.

In addition, because data communications between neighboring processors is performed through a shared memory, a communication overhead between the processors can be minimized, and thus, the video decoding apparatus can be effectively implemented with limited memory resources.

Moreover, because the number of stream buffers, shared memories, and processors can be variably adjusted depending on the performance of the video decoding apparatus and the size of the input stream, a high expandability and generality can be achieved.

While the present invention has been shown and described in connection with the exemplary embodiments, it will be apparent to those skilled in the art that modifications and variations can be made without departing from the spirit and scope of the invention as defined by the appended claims.

What is claimed is:

1. A multiprocessor-based video decoding apparatus comprising:
a stream parser dividing an input stream by row and parsing a skip counter and a quantization parameter of the input stream; and
a plurality of processors acquiring the plurality of divided streams, the skip counter and the quantization parameter generated by the stream parser, acquiring decoded information of an upper processor among neighboring processors by row, and parallel-decoding the plurality of divided streams by row.

2. The apparatus of claim 1, further comprising:
a plurality of stream buffers parallel-storing the plurality of divided streams generated by the stream parser; and
a plurality of shared memories shared by neighboring processors and providing decoded information of an upper processor among the neighboring processors to a lower processor among the neighboring processors.

3. The apparatus of claim 2, further comprising:
a frame memory storing the skip counter and the quantization parameter.

4. The apparatus of claim 3, wherein the decoded information of the upper processor comprises information regarding an X coordinate, a type, an intra and motion vector prediction values of a macroblock decoded by the upper processor among the neighboring processors.

5. The apparatus of claim 4, wherein each of the plurality of processors performs decoding on the divided stream stored in a stream buffer corresponding to each individual processor by using the skip counter and the quantization parameter stored in the frame memory and the intra and motion vector prediction values included in the decoded information of the upper processor.

6. The apparatus of claim 5, wherein each of the plurality of processors determines whether to perform decoding on the divided stream upon checking data dependency according to intra and motion vector direction through the X coordinate included in the decoded information of the upper processor.

7. The apparatus of claim 5, wherein each of the plurality of processors has a function of collecting the decoded information regarding the divided stream which has been decoded by each individual processor and storing the collected decoded information in a shared memory shared by each individual processor and a lower processor.

8. The apparatus of claim 5, wherein each of the plurality of processors further has a function of storing the result of the decoding operation in the frame memory.

9. The apparatus of claim 3, wherein the number of the plurality of stream buffers, the plurality of processors, and the plurality of shared memories may be adjustable according to the performance of the video decoding apparatus and the size of a stream to be processed.

10. A multiprocessor-based video decoding method using a stream parser and a plurality of processors, the method comprising:
a preprocessing and parsing operation of dividing, by the stream parser, an input stream by row and parsing a skip counter and a quantization parameter of the input stream;
an acquiring operation of acquiring, by the plurality of processors, the plurality of divided streams, the skip counter and the quantization parameter generated by the stream parser and acquiring decoded information of an upper processor among neighboring processors by row; and
a parallel-decoding operation of parallel-decoding, by the plurality of processors, the plurality of divided streams by row by using the information acquired by the plurality of processors in the acquiring operation.

11. The method of claim 10, wherein the preprocessing and parsing operation comprises:
dividing the input stream by row and parallel-storing the divided input streams in a plurality of stream buffers; and
parsing the input stream to extract the skip counter and the quantization parameter and storing the extracted skip counter and the quantization parameter in the frame memory.

12. The method of claim 11, wherein the acquiring operation comprises:
acquiring, by each of the plurality of processors, the divided streams stored in a stream buffer corresponding to each of the plurality of processors and the skip counter and the quantization parameter stored in the frame memory; and
reading, by each of the plurality of processors, a shared memory shared by each individual processor and an upper processor to acquire the decoded information of the upper processor by row.

13. The method of claim 12, wherein the decoded information of the upper processor may include information regarding an X coordinate, a type, an intra and motion vector prediction values of a macroblock decoded by the upper processor among the neighboring processors.

14. The method of claim 13, wherein the acquiring operation comprises:
determining whether to enter the acquiring operation upon checking data dependency according to intra and motion vector direction through the X coordinate included in the decoded information of the upper processor.

15. The method of claim 13, wherein the parallel-decoding operation comprises:
performing, by each of the plurality of processors, decoding on the divided streams acquired in the acquiring operation by using the skip counter and the quantization parameter and the decoded information of the upper processor; and
collecting, by each of the plurality of processors, decoded information regarding the divided streams which have been decoded by each individual processor and storing the collected decoded information in a shared memory shared by each individual processor and a lower processor.

16. The method of claim 10, further comprising:
storing, by the plurality of processors, the results of the decoding operation performed on the plurality of divided streams in the frame memory, after the parallel-decoding operation.
